(19) United States
(12) Patent Application Publication
(10) Pub. No.: US 2025/0240499 A1
(43) Pub. Date: Jul. 24, 2025

(54) SYSTEMS AND METHODS FOR ONLINE AND INTERACTIVE CONTENT CREATION AND ADVERTISING PLACEMENT AND MONETIZATION

(71) Applicant: Rumble Inc., Longboat Key, FL (US)

(72) Inventors: Slava Sterling, Venice, FL (US); Ewan Patrick Walker, North York (CA)

(21) Appl. No.: 18/981,048

(22) Filed: Dec. 13, 2024

Related U.S. Application Data
(60) Provisional application No. 63/630,315, filed on Jan. 20, 2024.

(51) Int. Cl. H04N 21/81; G06Q 30/0241; H04N 21/2187; H04N 21/4788; H04N 21/858

(52) U.S. Cl. CPC H04N 21/812; G06Q 30/0277; H04N 21/2187; H04N 21/4788; H04N 21/858

(57) ABSTRACT

New and improved interfaces for the live streaming of content by a content creator are provided. In a preferred embodiment the interface comprises a first area for displaying a live streaming video; a second area for displaying a live chat simultaneously with the live streaming video and a third area for displaying a plurality of advertisement opportunities simultaneously with the live streaming video and the live chat wherein each advertisement opportunity in the plurality of advertisement opportunities includes a script that can be read by the content creator during the live streaming video.

### CROSS-REFERENCE TO RELATED APPLICATIONS

This application claims the benefit of U.S. Provisional Application No. 63/630,315 filed on Jan. 20, 2024, which is herein incorporated by reference in its entirety.

### FIELD OF THE INVENTIONS

The inventions herein described, depicted and claimed relate to systems and methods that allow content creators to access an online audio-visual studio that will provide the tools needed for creation of high-quality audio-visual material which can then be made available for viewing by others via the internet, and, which will include additional tools that allow the user of the disclosed system and methods to concurrently monetize their content without leaving the online studio. Other tools will provide for tracking and accounting of that monetization. In yet another embodiment, the advertising placement aspect of the inventions herein disclosed may be enabled as a separate and distinct online portal and website where content creators may obtain advertising placement, monetization and tracking in relation to their previously created audio-visual content available for viewing. Other aspects and benefits of the inventions herein described, depicted and claimed will be apparent to those skilled in the art.

### BACKGROUND OF THE INVENTIONS

One result of the expansion of the internet has been the proliferation of what is sometimes referred to as “web content,” or in the internet ecosystem, simply “content.” Such content can be text, visual, audio or audio-visual material, such as music, videos, music videos, podcasts and the like, that is made available for viewing online. It is now estimated that between 500 and 1000 hours of content is uploaded to the internet every hour and is made available to the over 1.5 billion people who seek out internet content every day. It is predicted that this trend will continue apace.

There has also been a concomitant proliferation of “content creators,” that is individuals (and teams) who create content for distribution and viewing on the internet. These content creators range from amateurs, to the most recognized and popular personalities on the internet who have entire production teams. It is now estimated that there are over 200 million individuals who consider themselves to be internet content creators. And that number is expected to grow substantially. According to some polls, one in four American children now plan on becoming content creators.

While much of this content is still created in brick-and-mortar studios, such facilities are unavailable to the vast number of creators. For these creators, it is becoming increasingly common to use virtual studios These virtual studios provide to them the ability to create professional content without the expense of acquiring physical equipment.

The goal of most of these content creators is to monetize their online content; that is, to generate income. And this is being done more and more. No longer are content creators satisfied with just the number of views their content receives on a platform such as rumble.com, with the hope that their videos will go “viral” with the associated bragging rights. The amount of money earned by content creators globally is now well in excess of five billion dollars. Some of the more well-known and popular creators are able to charge a subscription fee for access to their content. The percentage of creators in this category, however, is very small. The most common way to monetize content is through advertising that is displayed either before, during or after the content is being viewed, or is displayed as a “banner” ad on the page with the content.

The typical way this has been done, and is still being done, is that the creator first creates the content in a format that can be viewed on the internet, and then, with that content “in hand” must upload that content to other websites in an attempt to interest advertisers in placing advertisements with that content. Or, more commonly, the creator can upload the content to a video sharing platform, such as rumble.com or YouTube. Those platforms will obtain advertising to be seen when that content (or the page on which the content is placed) is viewed, and will share a portion of the resultant advertising revenue with the creator.

There are many virtual studios online today that allow content creators to create, customize and broadcast their content. Some of these are:

Stream Yard (www.streamyard.com). Stream Yard is primarily a livestreaming tool. It allows for custom graphics and overlays, which can be used to display sponsor logos or messages. It does not include any direct feature for playing ads or direct monetization of the content created. The creator would need to upload the content to another platform, such as YouTube, to monetize the content by receiving a portion of the ad revenue generated through views of the content on that platform.

Restream.io (https://restream.io): Restream allows the content creator to broadcast to multiple platforms simultaneously. It allows the addition of custom graphics and logos, which can potentially be used for sponsorships. It also allows chat overlay features where sponsored messages could potentially be highlighted. It does not, however, have a feature for directly monetizing the content. Monetization would occur through the individual streaming platforms as described above.

Be.Live (https://be.live): This platform is focused on the interactive and engagement aspects of live streaming. Be.Live supports custom branding and graphics, which can be used for showcasing sponsor content. It also offers features like on-screen agenda and product showcasing that could be utilized for sponsor promotions. It does not include ad play or direct monetization features. Monetization would occur through the individual streaming platforms as described above.

vMix (www.vmix.com): vMix provides live production software, and provides an extensive array of video production tools that can be used by the content creator. However, it does not have built-in features for ad playback or direct monetization of the content produced. Monetization would occur through the individual streaming platforms as described above.

OBS Studio (Open Broadcaster Software) (https://obsproject.com): OBS provides free, open-source broadcasting software that the content creator can use to broadcast content. OBS is highly customizable and supports the addition of images, text, and video sources. This flexibility makes it suitable for integrating sponsor logos, banners, or video ads into the live stream. OBS does not, however, include built-in monetization or ad playback features. Monetization would occur through the individual streaming platforms as described above.

Wirecast (https://www.wirecast.io): Similar to OBS and vMix, Wirecast is focused on live production and streaming capabilities. Wirecast allows for custom graphics, overlays, and videos, which can be used for sponsor integration. Its professional production features enable a high degree of customization for showcasing sponsor content. Wirecast does not, however, offer direct monetization or ad playing features within the software. Monetization would occur through the individual streaming platforms as described above.

Ecamm Live (www.ecamm.com): The software offered by this site is tailored for live production specifically on an Apple Mac computer. Ecamm Live supports custom overlays, graphics, and scenes, making it possible to integrate sponsor logos or messages into the stream. It also offers features like interview mode, where sponsor content can be discussed or displayed. It does not, however, natively support ad playback or direct monetization features. Monetization would occur through the individual streaming platforms as described above.

There are also published patent applications that relate to online studios for use by content creators. One such application is entitled SYSTEM AND METHOD FOR ONLINE INTERACTIVE RECORDING STUDIO, U.S. Pub. No. US 2012/0096371 (published Apr. 19, 2012), by Joseph J. D'Anna. This application discloses a system and method for an on-line music studio that relates to the management and synchronization of online musical tracks created by musicians and enthusiasts, including individuals are not musicians. It discloses an on-line forum and technical workspace where both new and experienced songwriters, musicians, and producers of all experience levels and backgrounds can come to integrate and synchronize separate musical tracks from multiple, geo-graphically distant, users in real time, into a single complete musical composition. It does not, however, include any feature for monetization of the content created.

Another such patent application is entitled CREATING AND DISSEMINATING OF USE GENERATED CONTENT OVER A NETWORK, U.S. Pub. No. US 2023/0199142 (published Jun. 22, 2023), by Shane Pollack, Playvuu, Inc. as Applicant. This application discloses methods and systems for allowing a user to create and disseminate audio and video content over a network. For example, when a request to create audio content over a network is received, such as a request to create multimedia content comprising audio and video content over a network, in response to the request the user is presented with a plurality of compositions and other available content to be used, for example, as background music. The user can add additional content, such a lyrics, and then is able to record the composition of music with lyrics.

As is apparent from this description of prior art, providing an online studio for the creation of audio-visual content is old in the art. What has not been available to the individual content creators until now, however, is the ability to monetize their content effectively other than on a content-sharing platform that will publish the content, collect ad revenue, and share a portion of it with the content creator. While this is one way, it is not the best way for many if not most content creators. For example, for a creator's content that is published on YouTube (owned by Google), the content creator receives a very small percentage of the ad revenue that is generated by views of that content on YouTube. It would be greatly beneficial for these individual content creators if they could monetize their content more directly, without having to rely on YouTube, for example.

Therefore, notwithstanding the many prior art implementations of an online studio, there exists a long-felt need in the art for a method and system that will allow content creators to create content using an online interactive studio, and to concurrently with that creation to monetize the content with advertising to generate ad revenue directly to the content creator, there is also a long felt need in the art for a method and system whereby content creators can directly monetize their content even without having created that content using the online studio.

The inventions hereinafter described provide such methods and systems.

### SUMMARY OF PREFERRED EMBODIMENTS

Generally, methods and systems are disclosed that provide an online, interactive studio for the creation by the user of content, whether that content be audio only, visual only, or an audio-visual combination. The methods and systems provide easy-to-use tools such that even an amateur and novice creator will be able to create professional appearing content effectively, efficiently and at a very reasonable cost. The preferred method and system will also provide tools whereby the content creator can publish (for example, by live streaming) the newly-created content. In this first embodiment, the interface for the method and system will include tools that allow the user who is using the studio interface to directly access available advertisements from an online advertising campaign interface.

The advertising campaign interface provides methods of offering advertisement opportunities to content creators during a live stream video. In preferred embodiments, the method of offering advertisement opportunities comprises providing an interface that displays a live stream video in real time to a content creator. At the exact same time, a plurality of advertisement opportunities is displayed to the content creator on the interface with the live stream video. Each advertisement opportunity includes a script the content creator must read during the live stream video. When a selection is received from the content creator selecting an advertisement opportunity from the plurality of advertisement opportunities the script of the selected advertisement opportunity is displayed to the content creator so the content creator can read the script during the live stream. The live stream is monitored for successful execution of the script.

In preferred embodiments, the method further comprises providing feedback to the content creator regarding whether or not the advertisement opportunity selected by the content creator was completed successfully. In some of those embodiments, the feedback includes a dollar amount earned by the content creator during the live stream video.

In preferred embodiments, each advertisement opportunity in the plurality of advertisement opportunities includes a selection interface designed to allow the content creator to accept the advertisement opportunity. In most embodiments, the selection interface is a button but other types of selection interfaces may be used.

In some embodiments, the method further comprises causing a hyperlink associated with an owner of the advertisement opportunity selected by the content creator to be added to the live stream video in real time when the content creator selects the advertisement opportunity. The hyperlink may be added instantaneously with the selection or when the content creator determines based on some criteria such as the reading of the script during the live stream. In some embodiments, the hyperlink is added in a live chat interface simultaneously displayed with the live video stream.

In yet other embodiments, the method further comprises displaying an earnings per live viewer monetary amount to the content creator for each advertisement opportunity in the plurality of advertisement opportunities.

In still yet other embodiments, the method further comprises displaying an advertisement opportunity owner to the content creator for each advertisement opportunity in the plurality of advertisement opportunities.

In some embodiments, the method further comprises displaying an interface to owners of the plurality of advertisement opportunities that allows the owners to create the plurality of advertisement opportunities for display to the content creators.

In other aspects of the invention, an interface for live streaming of content by a content creator is provided. In preferred embodiments, the interface comprises a first area for displaying a live streaming video; a second area for displaying a live chat simultaneously with the live streaming video; and a third area for displaying a plurality of advertisement opportunities simultaneously with the live streaming video and the live chat wherein each advertisement opportunity in the plurality of advertisement opportunities includes a script that must be read by the content creator during the live streaming video.

In some embodiments, the third area of the interface is designed to display the script when the content creator selects an advertisement opportunity from the plurality of advertisement opportunities. In some of those embodiments, the non-selected advertisement opportunities are temporarily removed from the third area such that the script from the selected advertisement opportunity may be displayed.

In preferred embodiments, the interface further comprises feedback to the content creator regarding whether or not an advertisement opportunity from the plurality of advertisement opportunities was completed successfully. In some of those embodiments, the feedback includes a dollar amount earned by the content creator during the live stream video for execution of one or more advertisement opportunities from the plurality of advertisement opportunities.

In some embodiments, the third area displays each advertisement opportunity in the plurality of advertisement opportunities as a list and includes a selection interface designed to allow the content creator to accept one or more advertisement opportunities from the plurality of advertisement opportunities. As may be appreciated, a list is not required and other methods of displaying the plurality of advertisement opportunities may be used.

In preferred embodiments, the first area is designed to display a hyperlink associated with an owner of an advertisement opportunity overlayed on top of the live stream video in real time when the content creator is executing an advertisement opportunity of the owner.

In preferred embodiments, the second area is designed to insert the hyperlink in the live chat.

In some embodiments, the third area further displays an earnings per live viewer monetary amount to the content creator for each advertisement opportunity in the plurality of advertisement opportunities. In some embodiments, the third area further displays an advertisement opportunity owner to the content creator for each advertisement opportunity in the plurality of advertisement opportunities

In a further preferred embodiment, the method and system will also include tools by which the user can instantaneously submit to the advertiser confirmation that the selected advertisement(s) have been displayed as per their agreement (for example, placement and duration).

In a further preferred embodiment, the method and system will also provide tools whereby the user can concurrently confirm and track payment of the ad revenue.

In a further preferred embodiment, the method and system will omit the Rumble Studio aspect of the other preferred embodiments, and will present to the user a stand-alone interface for selecting advertising with content that is already created.

### BRIEF DESCRIPTION OF THE DRAWINGS

FIG. 1 shows an example of the first preferred embodiment in which studio interface also includes an interface with the advertising campaign interface.

FIG. 2 shows an example of the advertising campaign interface portion from FIG. 1, which could also be a stand-alone user interface.

### DETAILED DESCRIPTION OF THE DRAWINGS

The embodiments hereinafter described are the embodiments preferred at this time, and are not intended to and should not be interpreted to limit the scope of protection provided by this patent. Many modifications to the embodiments shown and described are possible without departing from the inventive concepts disclosed, depicted and claimed, and terms that are used for various aspects and components of the preferred embodiments are not limiting.

As used herein, the term “interface” means a software interface that allows a user to interact with the software. A software interface includes a web-based interface, mobile application interface or any other software platform interface.

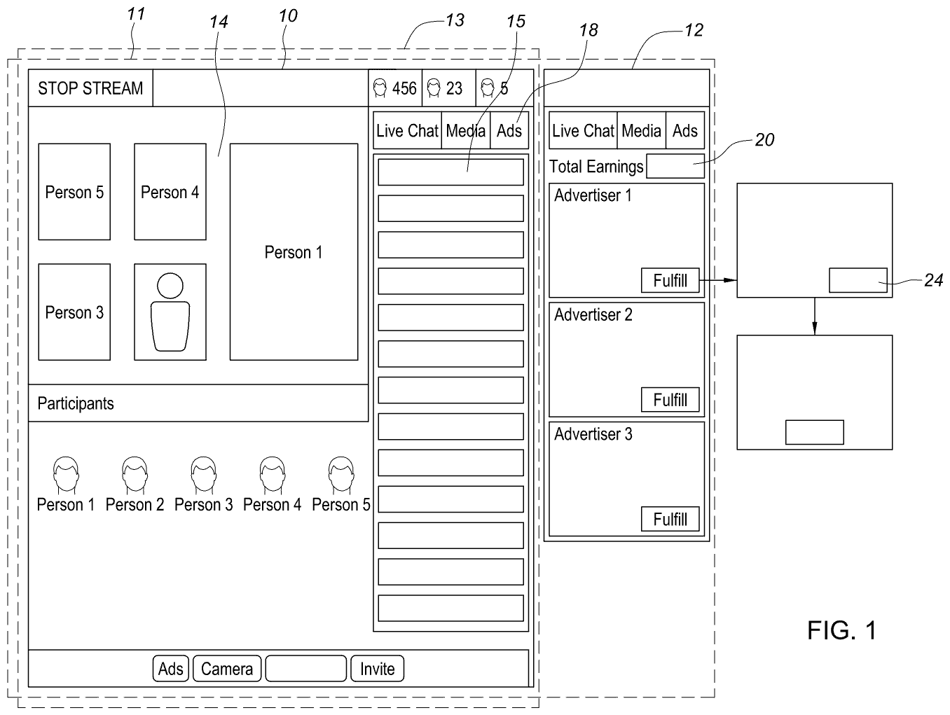

Referring to FIG. 1, a content creator is presented with the entire interface 11, within the dashed line. The interface 11 may be comprised of several different areas as shown in FIG. 1. In the embodiment shown in FIG. 1, the interface 11 is made up of everything inside the dashed line labeled 13 which is directed to the creation of content by the content creator and then the remainder displayed outside the dashed line labelled 13 which is directed to displaying advertisement opportunities and allowing the content creator to select an advertising opportunity in real time while creating content.

In the embodiment shown in FIG. 1, the interface portion inside dashed line 13 may be referred to as the studio interface 10. The interface portion outside the dashed line labeled 13 may be referred to as the ad campaign interface 12. As may be appreciated from FIG. 1, the interface 11 is the combination of the studio interface 10 with the ad campaign interface 12.

One important aspect of the inventions taught herein is that a content creator can see both the studio interface 10 and the ad campaign interface 12 simultaneously. Accordingly, while a content creator is creating content, for example by live streaming, the content creator can also be simultaneously viewing advertisement opportunities available to them on the ad campaign interface 12.

In the embodiment shown in FIG. 1, the studio interface 10 and the ad campaign interface 12 are shown side-by-side. However, one skilled in the art will appreciate that these portions/areas of interface 11 may be displayed in numerous other configurations and integrated in many different ways. The important aspect is that a content creator has real time access to advertisement opportunities simultaneously with a content creator's ability to create content.

Although generally speaking, the teachings herein can apply to any content creation and any advertisement creation, the disclosure herein is specifically directed to live streaming and the advertisement opportunities specific to live streaming where the content creator is reading a script during the live stream event. Of course, endless other types of content creation and advertisements may be used with the teachings herein but in particular, Applicant teaches methods and systems to allow content creators that are live streaming the ability to select advertisement opportunities where the content creators read a script during the live streaming event.

Returning to FIG. 1, it may be appreciated that interface 11 includes a first area 14 where the content creator can view one or more live streams. The studio interface 10 allows multiple persons to be involved in the live stream 14 simultaneously.

Interface 11 further has a second area 15 where the content creator can view and participate in a live chat simultaneously with the viewing of the live stream in the first area 14.

Interface 11 further comprises a third area 12, the advertising campaign interface 12, where the content creator can view advertisement opportunities simultaneously with the live stream and the live chat.

In preferred embodiments, each advertisement opportunity includes a script the content creator must read during the live stream to complete the advertisement opportunity and get compensated. In preferred embodiments, each advertisement opportunity displays the necessary details to allow a content creator to determine if the content creator would like to participate in the advertisement opportunity. For example, in some embodiments, each advertisement opportunity may display the owner of the advertisement opportunity, a monetary value associated with the advertisement opportunity and a portion or all of the script the content creator must read during the live chat. In addition, each advertisement opportunity may have a selection interface, such as a button, to allow the content creator to accept the advertisement opportunity.

It should be appreciated that although some of the details of each advertisement opportunity that would be helpful to a content creator to see have been described, in other embodiments, other details about the advertisement opportunity may be displayed. For example, advertisement opportunities may show the content creator any one or more of the following: brand, company, product details, script, advertiser guidance, pricing style (cost per live view or cost per live read) and an estimate. Estimates may be based on the point in time of the live stream, i.e. number of current viewers, or some other criteria.

In preferred embodiments, a monetary value for each advertisement opportunity is shown to the content creator. To this end, the content creator knows how much a potential advertiser will pay before agreeing to perform the advertisement opportunity. In some embodiments, the monetary value is set as the price the advertiser is willing to pay for each live viewer on the live stream (“CPLV”). This may be displayed as the monetary value for each single viewer or in more advance embodiments, a single dollar amount that calculates the total revenue based on the current number of live viewers on the content creator's live stream.

As may be seen in FIG. 1, in preferred embodiments, the advertising campaign interface 12 shows the advertisement opportunities as a list. This is the preferred method because it allows the content creator to quickly scroll through what's available to them. In other embodiments, other methods may be used including tiling, icons both large and small and other display schemes.

In preferred embodiments, the content creator may select an advertisement opportunity from the list of advertisement opportunities. Accordingly, the system receives a selection from the content creator of an advertisement opportunity from the plurality of advertisement opportunities. In preferred embodiments, the selection of an advertisement opportunity by the content creator causes the script to be displayed to the content creator. In some embodiments, when a content creator selects an advertisement opportunity, the list of potential advertisement opportunities may be replaced with the full details of the selected advertisement opportunity including the full script. The full script may be shown simultaneously with the live streaming video and the live chat such that the content creator can easily read the script while performing the live stream. In other embodiments, the full script may be shown to the content creator in other ways such as in a pop-up window.

To the extent the advertising campaign interface 12 is not shown when a content creator enters the studio interface 10, a button 18 may be used on the studio interface 10 that will allow the user to immediately access the ad menu on the advertising campaign interface 12, and other buttons and icons will allow the user to designate the advertisements to be included with the user's livestreamed content. Also seen in FIG. 1 is the user's access icon 20 that provides to the user a real time reporting of the total amount of ad revenue that the user has earned during the content livestreaming. Buttons 24 are provided which will allow the user to immediately self-report fulfillment of the terms of the ad placement, for example, location, when displayed and duration.

The specific icons and tools displayed in FIG. 1 are not limiting in any way. Many different functions and icons that are typical for an interactive online studio may be included depending on the embodiment.

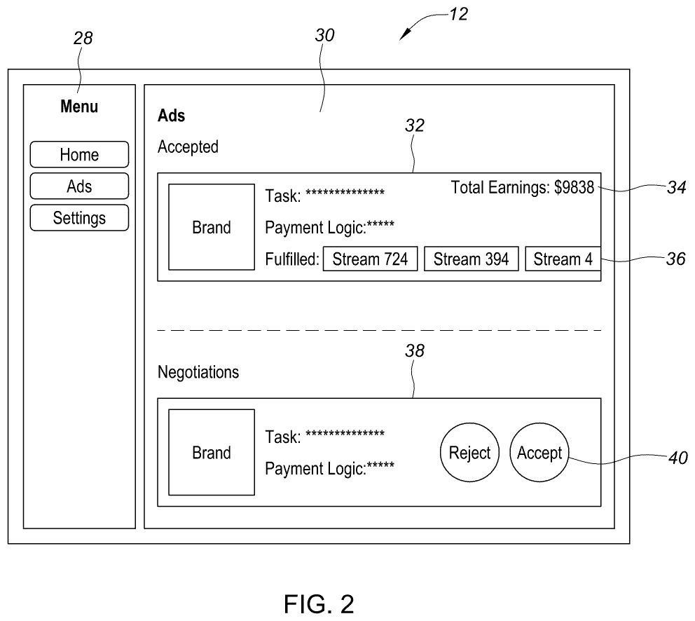

Turning now to FIG. 2, the advertising campaign interface 12 is shown in more detail and in isolation, i.e. without the studio interface 10. In some embodiments, the advertising campaign interface 12 comprises the advertising campaign menu 28, which presents to the user all aspects of the advertising campaign interface 12 offerings.

The various ads that are accepted will be shown in window 30. A display 32 of active ads in the livestreaming content is shown to the user, total earnings 34 are also shown on a real-time basis, and the livestreamed content event(s) that have fulfilled the terms of the ad placement are shown on the display 36.

The lower portion of the advertising campaign interface 12 may have a display 38 of the pending negotiations for ad placement, and the user will be able to instantly accept or reject the offer from the advertising using buttons 40. As with the studio interface 10, many more features, displays, icons, information and activating buttons may be added without departing from the inventive concepts disclosed herein.

In the preferred methods taught herein, after the content creator reads a script during a live feed, there is a monitoring system in place that monitors the execution of the script and decides whether the requirements of the advertisement opportunity were met by the content creator. In some embodiments, this may be done by software and in particular artificial intelligence software that compares the script to what was spoken during the live feed and provides a compatibility score. If the compatibility score is high enough, the advertisement opportunity is deemed completed by the content creator and the content creator is automatically paid the established monetary compensation for the advertisement opportunity.

In yet other embodiments, the execution of the script by the content creator is reviewed by a live human who determines whether the script was executed sufficiently to allow compensation. In both cases, feedback may be provided to the content creator.

While preferred embodiments of various aspects of the overall methods and systems have been described in detail above, it would be understood by a person skilled in the art that many modifications of and to the preferred embodiments can be made without departing from the inventive concepts herein described. Therefore, the above detailed description is not limiting, and the scope of the protection provided herein is based upon the claims set forth below.

What is claimed is:

1. A method of offering advertisement opportunities to content creators during a live stream video comprising:
providing an interface that displays a live stream video in real time to a content creator;
displaying a plurality of advertisement opportunities to the content creator simultaneously on the interface with the live stream video, wherein each advertisement opportunity includes a script the content creator must read during the live stream video;
receiving a selection from the content creator of an advertisement opportunity from the plurality of advertisement opportunities and causing the script to be displayed to the content creator; and
monitoring the live stream video for successful execution of the script.

2. The method of claim 1, further comprising providing feedback to the content creator regarding whether or not the advertisement opportunity selected by the content creator was completed successfully.

3. The method of claim 2, wherein the feedback includes a dollar amount earned by the content creator during the live stream video.

4. The method of claim 1, wherein each advertisement opportunity in the plurality of advertisement opportunities includes an interface design to allow the content creator to accept the advertisement opportunity.

5. The method of claim 1, further comprising causing a hyperlink associated with an owner of the advertisement opportunity selected by the content creator to be added to the live stream video in real time when the content creator selects the advertisement opportunity.

6. The method of claim 5, wherein the hyperlink is added in a live chat interface simultaneously displayed with the live video stream.

7. The method of claim 1, further comprising displaying an earnings per live viewer monetary amount to the content creator for each advertisement opportunity in the plurality of advertisement opportunities.

8. The method of claim 7, further comprising displaying an advertisement opportunity owner to the content creator for each advertisement opportunity in the plurality of advertisement opportunities.

9. The method of claim 1, further comprising displaying an interface to owners of the plurality of advertisement opportunities that allows the owners to create the plurality of advertisement opportunities for display to the content creators.

10. A method of offering advertisement opportunities to content creators during a live stream video comprising:
providing an interface that displays a live stream video in real time to a content creator;
displaying a plurality of advertisement opportunities to the content creator simultaneously on the interface with the live stream video, wherein each advertisement opportunity includes a script the content creator must read during the live stream video; and
receiving a selection from the content creator of an advertisement opportunity from the plurality of advertisement opportunities and causing the script to be displayed to the content creator.

11. The method of claim 10, further comprising providing feedback to the content creator regarding whether or not the advertisement opportunity selected by the content creator was completed successfully.

12. The method of claim 11, wherein the feedback includes a dollar amount earned by the content creator during the live stream video.

13. The method of claim 10, wherein each advertisement opportunity in the plurality of advertisement opportunities includes an interface design to allow the content creator to accept the advertisement opportunity.

14. The method of claim 10, further comprising causing a hyperlink associated with an owner of the advertisement opportunity selected by the content creator to be added to the live stream video in real time when the content creator selects the advertisement opportunity.

15. The method of claim 14, wherein the hyperlink is added in a live chat interface simultaneously displayed with the live video stream.

16. The method of claim 10, further comprising displaying an earnings per live viewer monetary amount to the content creator for each advertisement opportunity in the plurality of advertisement opportunities.

17. The method of claim 16, further comprising displaying an advertisement opportunity owner to the content creator for each advertisement opportunity in the plurality of advertisement opportunities.

18. The method of claim 10, further comprising displaying an interface to owners of the plurality of advertisement opportunities that allows the owners to create the plurality of advertisement opportunities for display to the content creators.

19. A method of offering advertisement opportunities to content creators during a live stream video comprising:
providing an interface that displays a live stream video in real time to a content creator;
providing an interface that displays a live chat simultaneously with the live stream video to the content creator;
displaying a plurality of advertisement opportunities to the content creator simultaneously on the interface with the live stream video, wherein the display of each advertisement opportunity includes an owner, a monetary compensation and a script the content creator must read during the live stream video;
receiving a selection from the content creator of an advertisement opportunity from the plurality of advertisement opportunities and causing the script to be displayed to the content creator; and
monitoring the live stream video for successful execution of the script.

20. The method of claim 19, further comprising causing a hyperlink associated with the owner of the advertisement opportunity selected by the content creator to be added to an end user's display of the live stream video and the live chat in real time.

21. An interface for the live streaming of content by a content creator comprising:
a first area for displaying a live streaming video;
a second area for displaying a live chat simultaneously with the live streaming video;
a third area for displaying a plurality of advertisement opportunities simultaneously with the live streaming video and the live chat wherein each advertisement opportunity in the plurality of advertisement opportunities includes a script that must be read by the content creator during the live streaming video.

22. The interface of claim 21, wherein the third area is designed to display the script when the content creator selects an advertisement opportunity from the plurality of advertisement opportunities.

23. The interface of claim 21, wherein the interface further comprises feedback to the content creator regarding whether or not an advertisement opportunity from the plurality of advertisement opportunities was completed successfully.

24. The interface of claim 23, wherein the feedback includes a dollar amount earned by the content creator during the live stream video for execution of one or more advertisement opportunities from the plurality of advertisement opportunities.

25. The interface of claim 21, wherein the third area displays each advertisement opportunity in the plurality of advertisement opportunities as a list and includes a selection interface designed to allow the content creator to accept one or more advertisement opportunities from the plurality of advertisement opportunities.

26. The interface of claim 25, wherein the selection interface is a button.

27. The interface of claim 21, wherein the first area is designed to display a hyperlink associated with an owner of an advertisement opportunity overlayed on top of the live stream video in real time when the content creator is executing an advertisement opportunity of the owner.

28. The interface of claim 27, wherein the second area is designed to insert the hyperlink in the live chat.

29. The interface of claim 21, wherein the third area further displays an earnings per live viewer monetary amount to the content creator for each advertisement opportunity in the plurality of advertisement opportunities.

30. The interface of claim 29, wherein the third area further displays an advertisement opportunity owner to the content creator for each advertisement opportunity in the plurality of advertisement opportunities.

31. An interface for the live streaming of content by a content creator comprising:
a first area for displaying a live streaming video;
a second area, separate from the first, for displaying a live chat simultaneously with the live streaming video;
a third area, separate from both the first area and the second area, for displaying a plurality of advertisement opportunities simultaneously with the live streaming video and the live chat wherein each advertisement opportunity in the plurality of advertisement opportunities includes a script that must be read by the content creator during the live streaming video; and
wherein the third area is designed to display the script when the content creator selects an advertisement opportunity from the plurality of advertisement opportunities.

32. The interface of claim 31, wherein the interface further comprises feedback to the content creator regarding whether or not an advertisement opportunity from the plurality of advertisement opportunities was completed successfully.

33. The interface of claim 32, wherein the feedback includes a dollar amount earned by the content creator during the live stream video for execution of one or more advertisement opportunities from the plurality of advertisement opportunities.

34. The interface of claim 31, wherein the third area displays each advertisement opportunity in the plurality of advertisement opportunities as a list and includes a selection interface designed to allow the content creator to accept one or more advertisement opportunities from the plurality of advertisement opportunities.

35. The interface of claim 34, wherein the selection interface is a button.

36. The interface of claim 31, wherein the first area is designed to display a hyperlink associated with an owner of an advertisement opportunity overlayed on top of the live stream video in real time when the content creator is executing an advertisement opportunity of the owner.

37. The interface of claim 36, wherein the second area is designed to insert the hyperlink in the live chat.

38. The interface of claim 31, wherein the third area further displays an earnings per live viewer monetary amount to the content creator for each advertisement opportunity in the plurality of advertisement opportunities.

39. The interface of claim 38, wherein the third area further displays an advertisement opportunity owner to the content creator for each advertisement opportunity in the plurality of advertisement opportunities.

40. An interface for the live streaming of content by a content creator comprising:
a first area for displaying a live streaming video;
a second area, separate from the first, for displaying a live chat simultaneously with the live streaming video;
a third area, separate from both the first area and the second area, for displaying a plurality of advertisement opportunities simultaneously with the live streaming video and the live chat wherein each advertisement opportunity in the plurality of advertisement opportunities includes an owner, a price and a script that must be read by the content creator during the live streaming video; and
wherein the third area is designed to display the script when the content creator selects an advertisement opportunity from the plurality of advertisement opportunities.
